(19) United States
(12) Patent Application Publication
(10) Pub. No.: US 2003/0041102 A1
(43) Pub. Date: Feb. 27, 2003

(54) Methods and systems for scaling inappropriately-sized documents in a distributed environment

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/941,213

(22) Filed: Aug. 27, 2001

(51) Int. Cl. G06F 15/16

(52) U.S. Cl. 709/203

(57) ABSTRACT

Methods and systems for printing in a distributed environment are described. In one embodiment, at least one network service causes a user interface to be presented on a client device. The user interface is configured to notify a user that a printer selected by the user for printing a print job does not support a media type upon which printing is intended, A network service then performs a scaling operation so that the user's print job is printed on at least one different media type.

### TECHNICAL FIELD

This invention relates to printing and distributed environments, and more particularly concerns methods and systems for scaling inappropriately-sized documents in a distributed environment.

### BACKGROUND

As computer technology has advanced, the role of computers in our daily lives has expanded, as has the need for various peripheral or supporting devices. One typical peripheral device used with computers is a printer, which generates a hard copy of data that is used by the computer. The types and capabilities of printers available has similarly been expanding, resulting in a wide variety of printers with a range of printing capabilities, performance, and price.

One significant expansion in the use of computer technology is the networking of computers together. Networking computers together allows the computers to communicate with one another as well as with other devices, such as printers. As computer networks, such as the Internet, continue to develop, there is an increasing demand for additional and improved functionalities that draw upon and exploit the full computing potential of computer networks.

Within a computer network that supports multiple different printers, it is often convenient for users to be able to select, at will, which printer they wish to use for a particular print job. As printers can vary greatly, so too can the size and type of print media that each uses. For example, some printers may only print on 8½″×11″ while others may print only on A4 type paper. Yet other printers may be configured to print on both 8½″×11″ and A4, but for some reason (perhaps a media outage), the printers can only print on one type of media. This situation can present a problem. Specifically, if a print job intended to be printed on 8½″×11″ is instead printed on A4, the margins, as well as other parameters associated with the original print job, may not be correct. Conversely, if a print job intended to be printed on A4 is printed instead on 8½″×11″, the margins, as well as other parameters associated with the original print job, may not be correct.

If the full computing potential of computer networks is to be exploited, then solutions are going to be needed to address many of the issues pertaining to printing in a networked environment.

Accordingly, this invention arose out of concerns associated with providing improved methods and systems for printing in a distributed environment.

### SUMMARY

Methods and systems for printing in a distributed environment are described.

In one embodiment, at least one network service causes a user interface to be presented on a client device. The user interface is configured to notify a user that a printer selected by the user for printing a print job does not support a media type upon which printing is intended. A network service then performs a scaling operation so that the user's print job is printed on at least one different media type.

In another embodiment, a user selection is received via a web service and indicates a document that is to be printed on at least one media type. A web service retrieves the user-selected document from a web-accessible repository and receives a user selection of a printer upon which printing is to take place. A web service ascertains whether the media type(s) is(are) supported by the user-selected printer. If the media type(s) is(are) not supported by the user-selected printer, a scaling operation is performed on data comprising the document, and the document is printed on the user-selected printer.

### BRIEF DESCRIPTION OF THE DRAWINGS

FIG. 1 illustrates an exemplary distributed system in which inventive principles described herein can be used.

FIG. 2 illustrates an exemplary distributed system in which inventive principles described herein can be used.

FIG. 3 illustrates an exemplary Web-based architecture in which inventive principles described herein can be used.

FIG. 4 illustrates an exemplary user interface presented by a Web browser.

FIG. 5 illustrates an exemplary user interface in accordance with one embodiment.

FIG. 6 illustrates an exemplary user interface in accordance with one embodiment.

FIG. 7 illustrates an exemplary user interface in accordance with one embodiment.

FIG. 8 illustrates an exemplary user interface in accordance with one embodiment.

FIG. 9 illustrates an exemplary user interface in accordance with one embodiment.

FIG. 10 is a block diagram that illustrates an exemplary print job scaling module in accordance with one embodiment.

FIG. 11 is a flow diagram that describes steps in a method in accordance with one embodiment.

FIG. 12 is a flow diagram that describes steps in a method in accordance with one embodiment.

FIG. 13 is a flow diagram that describes steps in a method in accordance with one embodiment.

FIG. 14 illustrates an exemplary computer system in additional detail.

### DETAILED DESCRIPTION

Overview

Methods and systems for printing in a distributed environment are described. In one embodiment, at least one network service causes a user interface to be presented on a client device. The user interface is configured to notify a user that a printer selected by the user for printing a print job does not support a media type upon which printing is intended. A network service then performs a scaling operation so that the user's print job is printed on at least one different media type.

Exemplary Distributed System

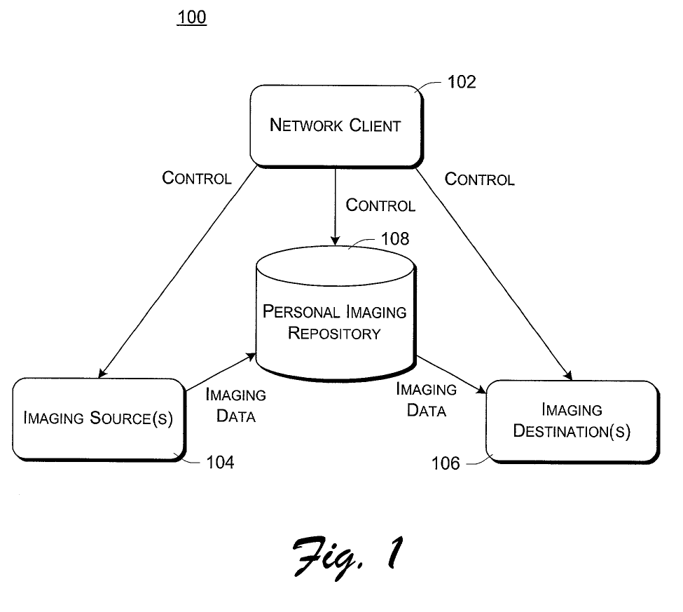

FIG. 1 illustrates an exemplary distributed system 100 in which various embodiments described below can be implemented. In system 100, a network client device 102 is in communication with one or more imaging sources 104, one or more imaging destinations 106, and a personal imaging repository 108. A user of client device 102 can communicate with imaging source(s) 104 to select or identify images to be stored in personal imaging repository 108. Imaging sources 104 represent any of a wide variety of devices that are capable of providing images to other devices. Examples of imaging sources 104 can include computers, cameras (e.g., digital still or video cameras), scanners, applications, Web sites, and so forth.

Repository 108 represents image storage facilities personalized to the individual user, although alternatively multiple users may have access to the same repository 108. Repository 108 is maintained on one or more computers, such as network client 102, an imaging source(s) 104, an imaging destination(s) 106, another computer (not shown), or combinations thereof. The imaging data in repository 108 can be any type of printable data, such as text, drawings, frames of video or animations, pictures, combinations thereof, and so forth.

The user, via network client 102, can select images from imaging repository 108 to be communicated to imaging destination(s) 106 for printing. In one aspect, the selected images from the repository can be communicated to the imaging destination in accordance with pre-defined print option configurations identified by the user, and as described in co-pending Patent Application Serial No. ______, entitled “Pre-defined Print Option Configurations for Printing in a Distributed Environment”, naming Shell Simpson, Ward Foster, and Kris Livingston as inventors, bearing Attorney Docket No. 10008181, the disclosure of which is incorporated by reference.

Imaging destination 106 represents any of a wide variety of devices that are capable of processing images in some manner. Examples of imaging destinations 106 include printers, plotters, services managing printing devices, and so on.

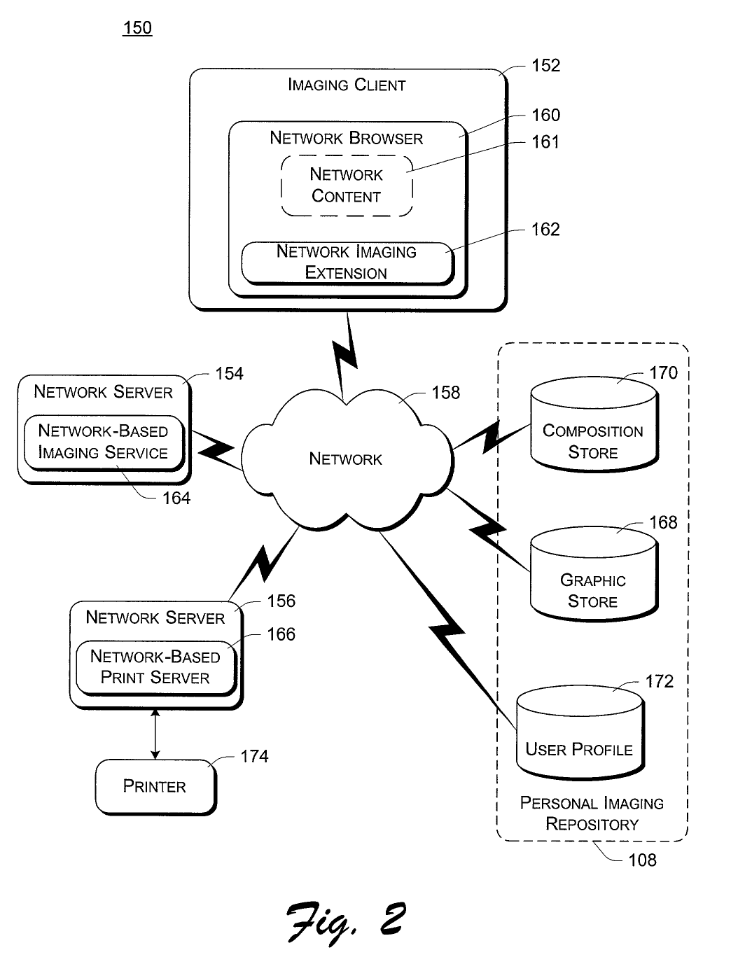

FIG. 2 shows an exemplary distributed system 150 in a distributed environment in additional detail. System 150 includes an imaging client 152 coupled to multiple network servers 154 and 156 via a network 158. Client 152 and servers 154 and 156 represent any of a wide variety of conventional wired and/or wireless computing devices, such as desktop computers, portable computers, dedicated server computers, multi-processor computing devices, cellular telephones, personal digital assistants (PDAs), handheld or pen-based computers, gaming consoles, and so forth.

Network 158 represents one or more conventional data distribution networks that can be used to communicate data and other information (e.g., control information) between or among various computing devices. Examples of network 158 include the Internet, a local area network (LAN), a public or private wide area network (WAN), combinations thereof, and so on. Network 158 can include multiple different types of networks, including wired and/or wireless portions, employing any of a wide variety of different communications protocols, including public and/or proprietary communications protocols.

During operation, a network browser 160 executing on imaging client 152 allows a user of client 152 to interact with network servers 154 and 156, as well as network services executing on such servers. Network browser 160 includes a network imaging extension 162 that allows network content 161 executing in browser 160 to communicate with the user's personal imaging repository 108, which may include communication with services via network 158. As used herein, services refer to software components that can execute on one or more computing devices and are accessible to provide functionality to imaging client 152, such as imaging sources, imaging destinations, printer configuration components, and so forth. Network imaging extension 162 can be implemented in any of a wide variety of manners, such as an application programming interface (API) providing methods that can be called by content 161 and used to interact with servers 154 and 156 (e.g., to load, save, modify, delete, etc. documents).

Network server 154 executes a network-based imaging service 164 that allows a user of browser 160 to interact with his or her personal imaging repository (e.g., add, remove, and/or modify graphics in the repository) and identify an image for printing. Images identified or selected for including in the user's personal imaging repository can be indicated by value (e.g., the actual image data) or by reference (e.g., a pointer to or identifier of the image stored elsewhere). The image to be printed can be made up of graphics from one or more different graphic sources, and include any type of printable data (e.g., text, graphics, and so forth).

Network-based imaging service 164 represents one or more services accessible to imaging client 152. Each service can execute on the same server or alternatively on multiple different servers. These different services can provide different functionality (e.g., one service may be responsible for graphic storage and retrieval functionality, while another service is responsible for merge functionality allowing graphics to be merged together). Additionally, some services may be fully or partially overlapping in functionality provided by other services, allowing a degree of fault-tolerance to be built into system 150 (e.g., one service can take over the responsibilities of another if the other fails).

The graphic for an image is received from a graphic store 168 and/or a composition store 170. Graphic store 168 stores individual graphics (also referred to as documents or more generally data capable of being represented as a two dimensional graphic), such as individual files. These individual graphics in store 168 can be used as individual printable images via imaging service 164. Each individual graphic can be any of one or more types of printable data (e.g., text, pictures, etc.), and may result in multiple hard copy pages when printed. Additionally, a user of browser 160 may identify multiple individual graphics from graphic store 168 that are to be compiled together as a single image for printing. In this situation, network-based imaging service 164 provides an interface that allows the user of browser 160 to select different individual images and store the compilation of individual images as a single composition document (also referred to as a composition image) in composition store 170. The composition document may include the actual data from the individual images, or alternatively identifiers (e.g., file name and path, or Uniform Resource Locators (URLs)) of where the individual images can be retrieved for printing or displaying to the user.

Graphic store 168 and composition store 170 are illustrated in system 150 as two separate stores. Alternatively, multiple such stores may exist in system 150, and one or more graphic stores may be combined with one or more composition stores. Additionally, one or more of these stores 168 or 170 may be implemented on one of servers 154 or 156, and/or imaging client 152.

Network-based imaging service 164 and/or network-based print server 166 also provides an interface via which a user of browser 160 can access imaging data in the form of documents, pages of documents, and portions thereof, and select them for printing. Service 164 and/or server 166 are also configured to present an interface that notifies a user in an event that a document print job (or portion thereof) is indicated to be printed on inappropriately sized paper. In one embodiment, the service or server can then provide the user with options on how they wish to handle the size mismatch. For example, the user can opt to have the image data comprising the print job scaled to the appropriate size. Alternately, the data comprising the print job can be manipulated to center the printed image on a page or align the printed image with one edge of the print media. Further, the interface can give the user the option of correcting the size mismatch on a page-by-page basis, or correct the misalignment for all of the pages at once. In another embodiment, the service 164 and/or server 166 is configured to automatically scale the image data comprising the print job so that it fits whatever media is available. If there is more than one type of media available, then the service or server can select the media that is the closest match to the media upon which the print job is intended to be printed. In this case, a user interface is presented that simply informs the user that the scaling has automatically taken place.

In other embodiments, a user is able to specify one or more scaling preferences, e.g. straight linear scaling, ratio of length to width, and the like. The scaling preferences are maintained, for example, in a user profile 172 and then presented to the user when scaling becomes necessary.

In another embodiment, the user can select media for printing and have documents scaled independent of whether that native media size is available or not. For example, scaling has traditionally been presented as something that happens when the destination printer is unable to support output to the specified media size—e.g. we have an A4 document but no A4 paper in a printer. In accordance with this embodiment, it is not necessary for the specified media size to be unavailable before scaling can be applied. For example, a document may be formatted for US Letter and the user desires to print an oversized version of it for some reason. In this embodiment, the user can simply select the appropriate options and scale the US Letter document to Tabloid (11×17) and print it twice as big as normal. This example of scaling is done because the user desires an alternate size—not because the native size is unavailable.

In order to print an image, the user identifies the image (optionally selecting graphics that are to be part of the image). A print request, including the image data is then communicated to network-based print server 166 executing on network server 156. Upon receipt of the print request, network-based printer server 166 interacts with a printer 174 coupled thereto to produce a hard copy of the image in accordance with the received image data. Part of the interaction that takes place can involve processing the print job to ascertain whether the media type on which the print job is intended for printing is supported by printer 174. If the media type is not supported by the printer 174, then processing can take place as described above (i.e. user-selected scaling at different levels of granularity, e.g. page-by-page or print job-by-print job, automatic scaling, and the like).

Exemplary Web-based Architecture

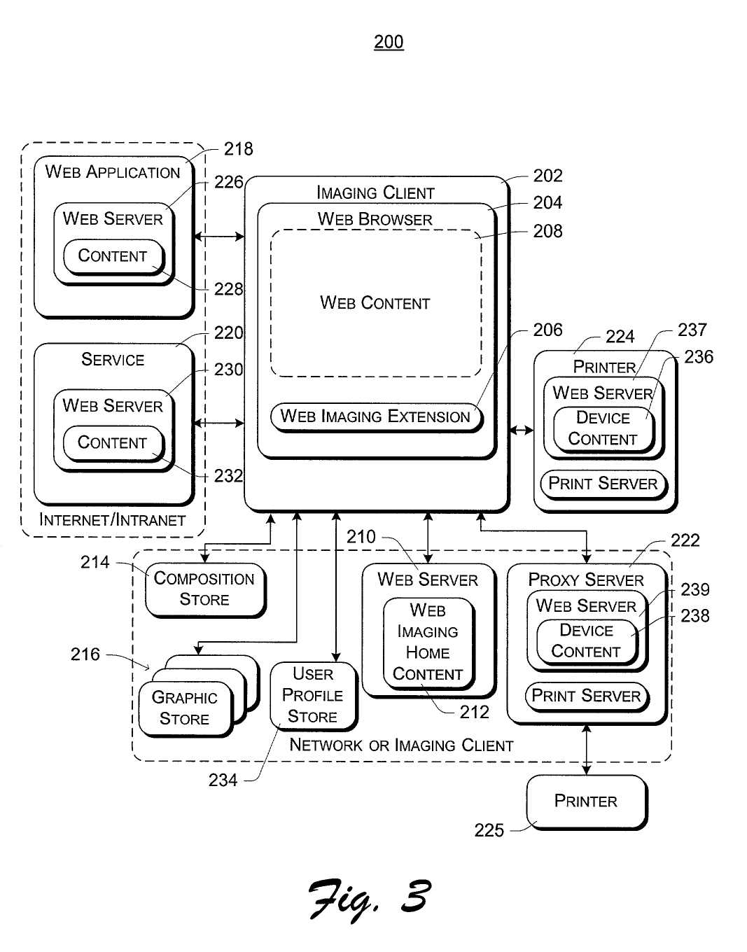

FIG. 3 illustrates an exemplary Web-based architecture 200 that is suitable for use in implementing the various described embodiments. Web-based architecture 200 refers to the World Wide Web (or simply the Web), which is a distributed collection of interlinked, user-viewable documents (typically referred to as Web documents or Web pages) that are accessible via the Internet. The Web also refers to the client and server components which provide user access to such documents using standardized Internet protocols. Currently, the primary standard protocol for allowing applications to locate and acquire Web documents is the HyperText Transport Protocol (HTTP), and the Web pages are encoded using a standard markup language such as the HyperText Markup Language (HTML) or eXtensible Markup Language (XML). Alternatively, other protocols or languages may be used.

In architecture 200, an imaging client 202 (i.e., similar to imaging client 152 of FIG. 2) includes a Web browser 204 including a web imaging extension 206. Browser 204 is able to load and execute web content 208 (e.g., Java scripts or programs) from various sources. In the illustrated example, Web browser 204 establishes a communication channel or connection with Web server 210, causing Web imaging home content 212 to be copied to imaging client 202 as at least part of Web content 208. Although illustrated as being copied from Web server 210, it is to be appreciated that Web imaging home content 212 could alternatively be loaded from a local or intermediary source, such as a cache (not shown) implemented on imaging client 202. Additionally, any inputs by the user to Web content 208 are typically handled by Web content 208 rather than being returned to Web imaging home content 212.

Once loaded in Web browser 204, Web content 208 can communicate, via Web imaging extension 206, with other components in architecture 200, allowing access to a personal imaging repository as well as imaging sources and imaging destinations. In the illustrated example, the personal imaging repository includes composition store 214 and graphic store 216, the imaging sources include Web application 218 and service 220, and the imaging destinations include proxy server 222 and printer 224.

Web application 218 includes a Web server 226 that maintains (or obtains/creates) content 228 accessible to Web content 208. Similarly, service 220 maintains a Web server 230 that maintains (or obtains/creates) content 232 accessible to Web content 208. The content 228 and 232, when generated (e.g., from a file or dynamically) and executed on imaging client 202 (e.g., as part of Web content 208), can make various functionality available to Web content 208, such as image sources, combine multiple graphics into a composition document, manipulate imaging data comprising print jobs to accommodate inappropriately sized documents, as will become more apparent below.

Printer 224 and proxy server 222 each optionally include a print server for queuing and managing received print requests, and a Web server 237 and 239 storing or dynamically generating device content 236 and 238, respectively. Device content 236 represents content (which may be generated dynamically) that is provided to the Web browser 204 by the Web server 237. Device content 236 is a Web service available to imaging client 202 that represents printer 224 and that can access the user's personal imaging repository. The device content 236, when downloaded and executed on client 202 (e.g., as part of Web content 208), can access the stores 214 and 216 via Web imaging extension 206 to obtain graphics and upload the graphics to printer 224 for printing. The upload to printer 224 is accomplished using existing conventional mechanisms (e.g., HTTP POSTs or TCP/IP socket connections) that allow content executing within the browser to communicate with the server from which that content came. In the illustrated example, imaging extension 206 is only used to obtain graphics from the personal imaging repository, not to upload the graphics to the printer. In addition, device content 236 can also process imaging data comprising a print job to accommodate inappropriately-sized documents.

Proxy server 222 allows a printer(s) that does not host a Web server to be represented by a Web service. Proxy server 222 includes device content 238 and Web server 239, which operate analogous to device content 236 and Web server 237, respectively. The printer 225 is represented by device content 238 and graphics obtained by the device content 238 (presented in the context of the device). This device content, when downloaded and executed on client 202 (e.g., as part of Web content 208), can upload graphics accessed through the imaging extension to proxy server 222, which in turn forwards these graphics to printer 225. In addition, device content 238 can also process imaging data comprising a print job to accommodate inappropriately-sized documents.

Web application 218 and service 220 may each be accessible by imaging client 202 via the Internet or via a local network (e.g., an Intranet). Each of the stores 214 and 216, as well as user profile store 234, Web server 210, and proxy server 222, may be accessible via a network (e.g., an Intranet or the Internet) and/or located on imaging client 202.

During operation, Web content 208 generates and renders, via Web browser 204, one or more user interfaces (e.g., graphical user interfaces (GUIs)) that allows the user to interact with his or her personal imaging repository. This interaction includes allowing the user to select images or documents for printing, to identify pre-defined printer configurations to be used in printing selected documents, and to select imaging data for processing to accommodate inappropriately sized documents for printing.

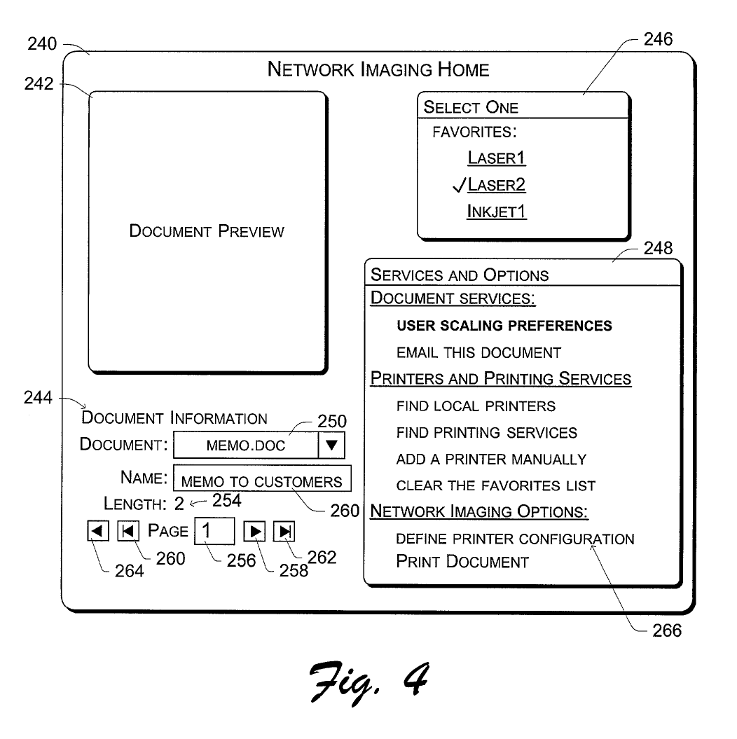

Example user interfaces rendered by Web content 208 are discussed below with reference to FIGS. 4-9. The various interfaces can be separate Web pages, or alternatively portions of another (or the same) Web page.

Exemplary UIs

FIG. 4 illustrates an exemplary user interface presented by Web browser 204 of FIG. 3. In the illustrated example, user interface 240 is displayed by Web browser 204 as a result of loading the Web imaging home content 212. User interface 240 includes a document preview window 242, a document information portion 244, a favorite printers portion 246, and a services and options portion 248. User interface 240 allows the user to select one or more documents for printing via document information portion 244. The user can select the desired document by name via a pull down menu input 250 or change the name of the selected document in name field 260. Alternatively, other document-selection input mechanisms may be supported, such as cutting and pasting of the document name, dragging and dropping an icon representing the document, supporting a “browse” feature allowing the user to search his or her personal imaging repository (or elsewhere) for documents, and so forth.

The length of the user-selected document (e.g., in pages) is illustrated in a length field 254. Document preview window 242 provides a location via which a small preview image of the document selected for printing (or other processing) is displayed to the user. A current page section 256 identifies the current page(s) being displayed in document preview window 242, and page manipulation buttons 258, 260, 262, and 264 allow the user to easily advance to the next page in the document, the previous page in the document, the last page of the document, or the first page of the document, respectively.

Favorite printers portion 246 identifies one or more printers that are selectable by the user for printing, and can include, for example, the user's preferred printers, suggested printers to be used by the user, default printers, and so forth. In the illustrated example, each printer identified in favorites portion 246 is identified by a hyperlink (illustrated as being underlined). The user can select one of the printers that the identified document is to be printed on by activating the hyperlink (e.g., by using a pointer control device to situate a pointer over the hyperlink on screen and click a button of the control device).

Services and options portion 248 allows the user to identify or request options or services, such as to add a printer to favorites portion 246, clear favorites portion 246, print the document, and so forth.

One of the services available for selection on the services and options portion 248 is a “user scaling preferences” portion. In this embodiment, a user can select this option so that in an event that one of their print jobs is intended for printing on a printer that does not support an associated media type, the document intended for printing can be scaled in accordance with the user's preferences. This can be an automatic operation in which the image data associated with a print job is processed such that the printed document is scaled to and printed on a media type closest to the intended media type. Alternately, the user, through presentation of a suitable UI, can be given the option of choosing a scaling function that they have indicated is a favorite.

FIG. 5 shows an exemplary user interface 266 that is presented by Web browser 204 of FIG. 3 responsive to a user selecting a document to print, where the selected printer does not support the media type upon which printing is intended. For example, assume that a user intends to retrieve a composition from their personal imaging repository and that the composition comprises imaging data that is configured to be printed on A4 paper. Assume also that the printer that has been selected by the user, as outlined above, does not support printing on A4 paper. When the user initiates the print job causing it to be sent, in this example, to a printer such as printer 224 (FIG. 3) having device content 236, the printer determines that it cannot print the composition on the desired paper type and thus causes the user to be notified accordingly. It can do this through the utilization of device content 236 which causes user interface 266 to be presented to the user.

In this particular example, user interface 266 notifies the user that their print job has defined an inappropriate media size for printing. The user interface can then present the user with one or more options. As an aside, it will be appreciated that some embodiments can simply recognize that a desired media size is not supported, and then automatically scale the imaging data of the print job thereafter notifying the user that scaling has been performed.

Continuing then, in this example, three options are presented to the user via user interface 266. First, the user can select an option 266a that automatically scales the document (in this case, the user's composition), to the closest available media type. So, if the user's print job is defined in terms of A4 paper and the closest available media type is 8½″×11″, then the entire document would be scaled automatically to 8½″×11″. Automatic scaling operations can be implemented using previously specified user parameters (i.e. scale linearly or scale by 80%), or parameters that are selected to optimize the appearance of a printed document given the media type upon which it is to be printed.

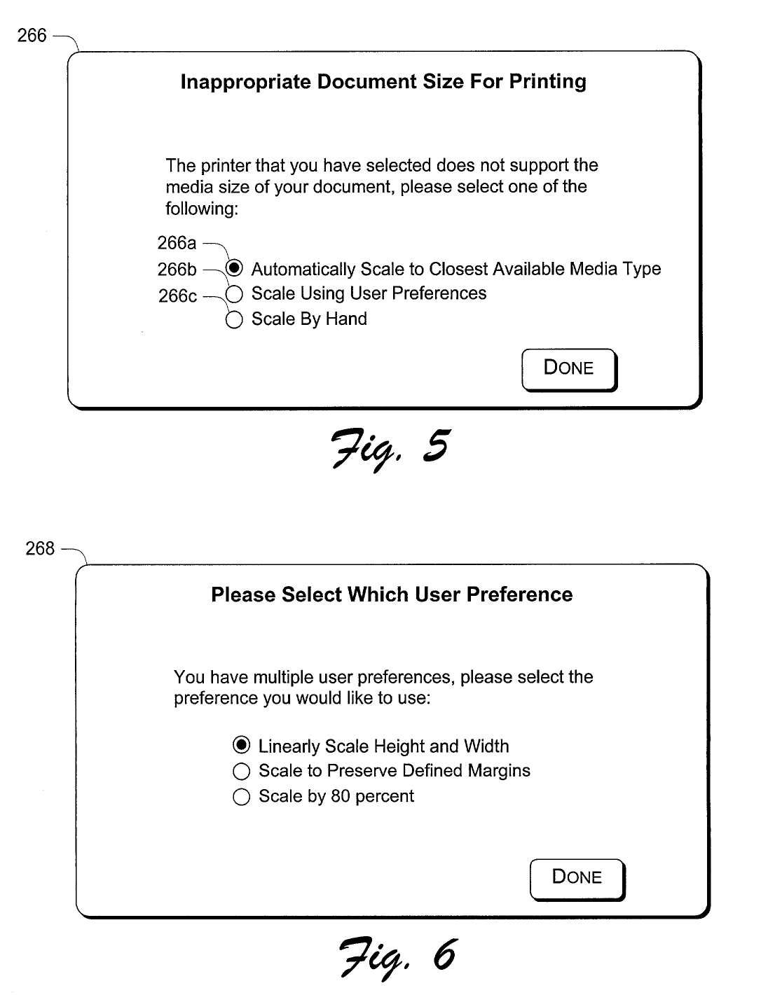

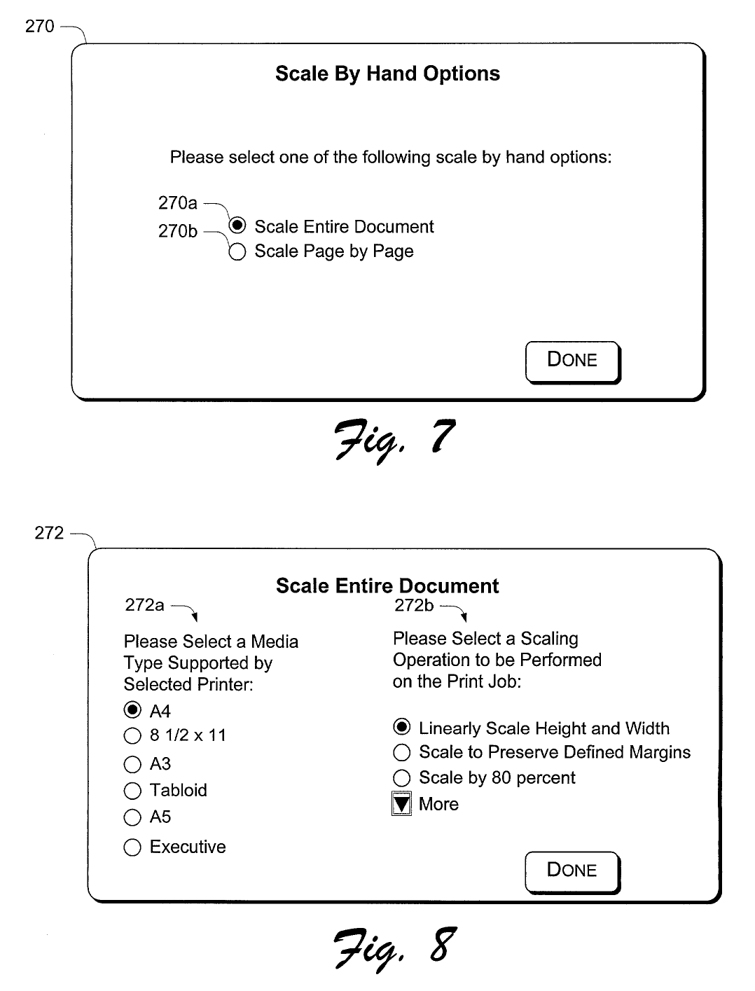

Another option 266b enables a user to have their print job scaled in accordance with preferences that have been selected by the user. This is discussed below in more detail in connection with FIG. 6. A third option 266c enables a user to have their print job scaled by hand. Here, the user is able to individually specify how the print job is to be scaled (either the entire print job or portions thereof). This is discussed in more detail in connection with FIGS. 7-9.

After making their selection, the user can click on the “Done” button which then causes their selection to be conveyed to the appropriate service, server or device through conventional means.

Scaling using the User Preferences Option

If the user selects option 266b, then their print job can be scaled in accordance with one or more user preferences. If, for example, the user has only one set preference, then the scaling operation can take place automatically. If, on the other hand, the user has, in their user profile store 234 (FIG. 3), multiple different preferences, then the user can be presented with a user interface to allow them to select, with more specificity, the particular user preference that they would like to use.

FIG. 6 shows an exemplary user interface 268 that can be presented to a user when the user has more than one user preference for scaling. Here, the user has three such user preferences from which to choose. In this particular example, the user has selected an option that enables the imaging data comprising their print job to be scaled linearly. When the user is finished, they can click on the “Done” button.

Scaling Using the by Hand Option

If the user selects option 266c (FIG. 5), then their print job can be scaled by hand. Accordingly, the user can be presented with one or more user interfaces that enable the user to interact with their print job at different levels of granularity.

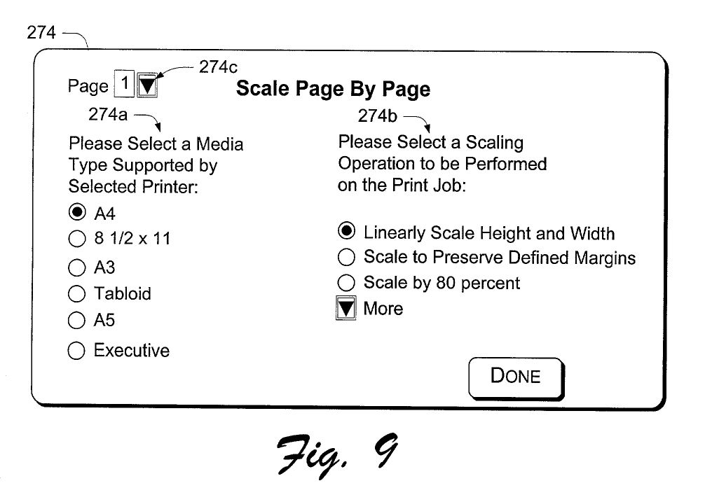

FIG. 7 shows a user interface 270 that presents a user with two different options for scaling by hand. Option 270a enables a user to have their entire print job scaled as they can further specify (as discussed in connection with FIG. 8). Option 270b enables a user to have their print job scaled page by page as they specify. When the user has selected their choice, they can click on the “Done” button to get to the next user interface.

Scale Entire Document

If the user selects option 270a, then their entire document will be scaled as they specify. FIG. 8 shows an exemplary user interface 272 in accordance with one embodiment. User interface 272 can enable a user to specify, on the print job level, how the entire print job or document is to be scaled. In this example, there are two fields that can be specified by the user. A first field 272a enables the user to select a media type that is supported by the selected printer. This field lists the media types that the printer supports. In this example, the selected printer supports six different media types: A4, 8½″×11″, A3, Tabloid, A5, and Executive. A second field 272b enables the user to specify a scaling operation that is to be performed on the imaging data comprising their print job. In this example, there are three listed scaling operations and a pulldown button to expose more operations that are available for selection.

The result of the user input at this interface is that the imaging data comprising their print job will be scaled as specified and printed on the media type selected by the user.

Scale Page By Page

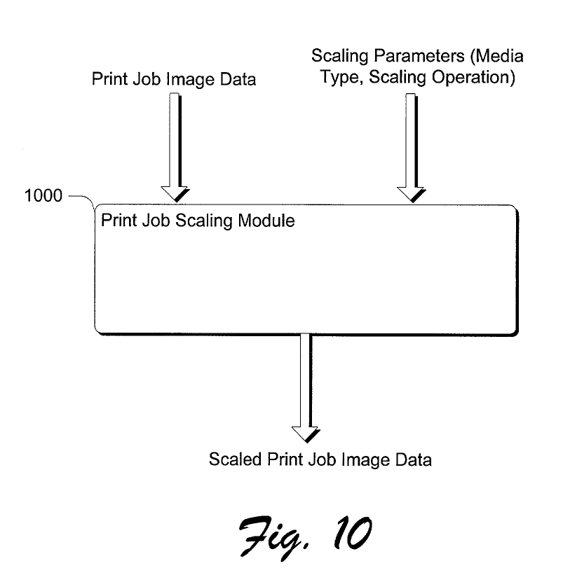

In the event the user selects option 270b (FIG. 7), then the user can specify how each page of their print job is to be scaled. FIG. 9 shows a user interface 274 having fields 274a and 274b that are the same as fields 272a and 272b respectively. In addition, user interface 274 includes a field 274c that enables a user to select each page of their print job and, in connection therewith, specify the media type and scaling operation to be performed on each page. Accordingly, a user can have individual pages of their print job printed on different types of media and scaled by different scaling operations.

When the user is done, they can click on the “Done” button to convey their choices to the appropriate service, server or printer.

Once the user has indicated all of their choices, a user interface (not illustrated) can be presented and can ask the user if they wish to preview their document, as it will appear in its newly scaled state. If the user wishes to preview their document, they can do so via a document preview window such as window 242 (FIG. 4). Additionally, the user can be given the option of saving their newly scaled composition as a new document in their personal imaging repository.

Exemplary Document Scaling Module

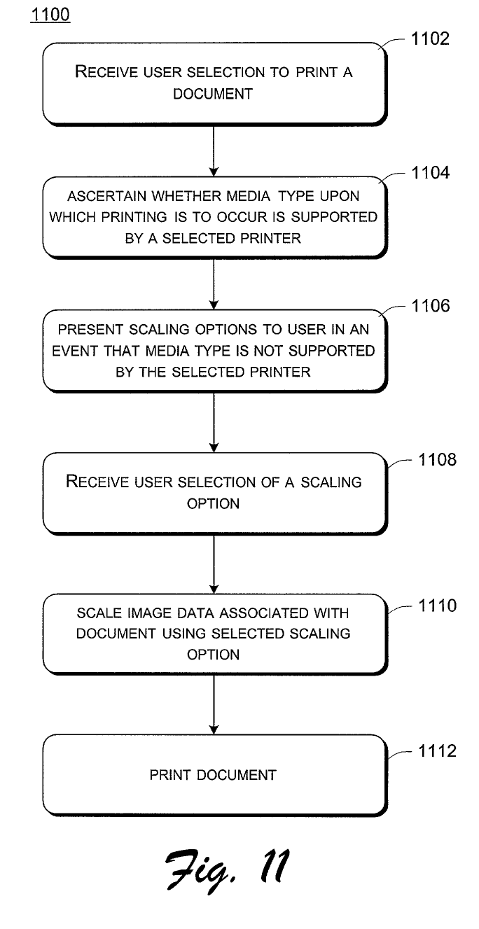

FIG. 10 shows an exemplary print job scaling module 1000 in accordance with one embodiment. The print job scaling module can be implemented in any suitable hardware, software, firmware, or combination thereof. In the illustrated example, the print job scaling module can be implemented in software.

In preferred embodiments, the print job scaling module 1000 is implemented as a network-based or Web-based service. Accordingly, such module can comprise a part of whatever system is providing such service. As an example, the print job scaling module 1000 can comprise part of content 228 of Web application 218 (FIG. 3), part of content 232 of service 220, part of content 212 of Web server 210, part of device content 238 of Web server 239, or part of device content 236 of Web server 237.

In this example, print job scaling module 1000 comprises functionality that enables a user to have their print job scaled for an appropriate media type that is supported by a selected printer.

In this example, the print job scaling module receives, as input, print job image data comprising the user's print job, and one or more scaling parameters that are associated with the print job. These parameters can be selected by the user, retrieved from a user preference store, or provided as part of an automatic scaling operation. The print job scaling module 1000 then processes the print job image data using the scaling parameters to provide scaled print job image data. This image data represents the original image data of the original print job, having been appropriately scaled.

Any suitable scaling techniques can be used to implement the scaling functionality. Those of skill in the art of image-processing will understand and appreciate the different techniques that can be used to scale image data. Accordingly, for the sake of brevity, such techniques are not described here in much detail. For example, there are different types of scaling techniques available depending on the nature of the image data. For example, image data in the PostScript language can be easily scaled by applying a simple coordinate transformation matrix (CTM) which makes the process quite simple. Raster (bitmapped) image data, such as JPEG and TIFF images, require much more complex algorithms to scale well. These algorithms will be understood and familiar to anyone skilled in the art.

Exemplary Printing Process

Returning to FIG. 3, the process of printing a document in system 200 can be seen from the following example. Via the interface provided by Web browser 204 and content 208, the user is able to access images from different imaging sources, such as Web application 218, service 220, graphic store 216, or composition store 214. Additionally, as described above, the user is able, through the provided user interfaces, to build a composition document by selecting, arranging and manipulating various pages from one or more documents. The user can also select, if provided, one of a variety of predefined printer configurations stored in user profile store 234. Exemplary printer configurations are described in the U.S. Patent Application incorporated by reference above. In accordance with this incorporated disclosure, the user can select a printer on which to print the selected document, such as printer 225 coupled to proxy server 222, or printer 224. When the user selects the print option, an identification of the document, in this case the composition document (as well as an identification of the configuration, if selected) is communicated to the appropriate printer. Additionally, the media type upon which printing is to occur is also communicated to the printer.

Upon receipt of the print request, the printer can perform a check to ascertain whether it can support the media type on which printing is intended. If the media type is supported by the printer, then printing can occur. If the media type is not supported by the printer, then the printer can take one or more of the actions described above (i.e. automatically scale the image data associated with the print job, inform the user that the media type is not supported and allow the user to select a scaling option and the like).

The print request communicated to the printer includes an identifier of the document that is to be printed. The identifier can also include an indication of the print media type. Any of a wide variety of identifiers can be used, such as a Uniform Resource Locator (URL). This may be an identifier of a single document (e.g., a document in graphic store 216), or an identifier of a composition document (e.g., a document in composition store 214) that itself includes identifiers of one or more other documents or pages from other documents. Alternatively, the data of the document to be printed may be communicated to the printer from the client 202 (along with an indication of the intended media type), such as by the device content 236 of FIG. 3 (when downloaded and executed on the client 202). The data of the document may be communicated with the print request, or alternatively subsequent to the print request.

Exemplary Methods

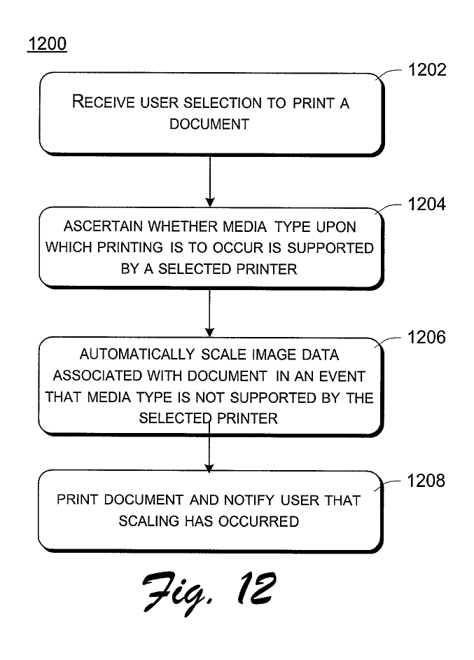

FIG. 11 is a flowchart illustrating an exemplary scaling process 1100 in accordance with one embodiment. The process of FIG. 11 is desirably performed by the above-described network-based or Web-based service which, as described, can be embodied in content 208, content 228, content 232, content 212, device content 236 or device content 238. In a preferred embodiment, the process is implemented, at least in part, in connection with a service associated with a printer.

Step 1102 receives a user selection to print a document. This step is implemented by causing a user interface to be displayed via which the user can select a document for printing. Step 1104 ascertains whether the media type upon which printing is to occur is supported by a selected printer. The step can be implemented in any suitable way. For example, in some embodiments, a media type can be embedded in an identifier that is associated with a document that is to be retrieved and printed. In this instance, the process would simply check the media type in the identifier with the media types supported by the printer. Alternately, a media type can comprise part of the image data of the print job that is sent to a printer. Other ways of conveying a media type for an associated document to be printed can be used.

In an event that a particular media type is not supported by a particular printer on which printing is to occur, step 1106 presents one or more scaling options to a user. But one example of specific scaling options and how they can be presented is shown and described in connection with FIG. 5 above.

Step 1108 receives a user selection of a scaling option and step 1110 scales image data associated with the document using the selected scaling option. Step 1110 can be implemented using standard scaling techniques that will be known and appreciated by those of skill in the art. Step 1112 then prints the document on the selected printer.

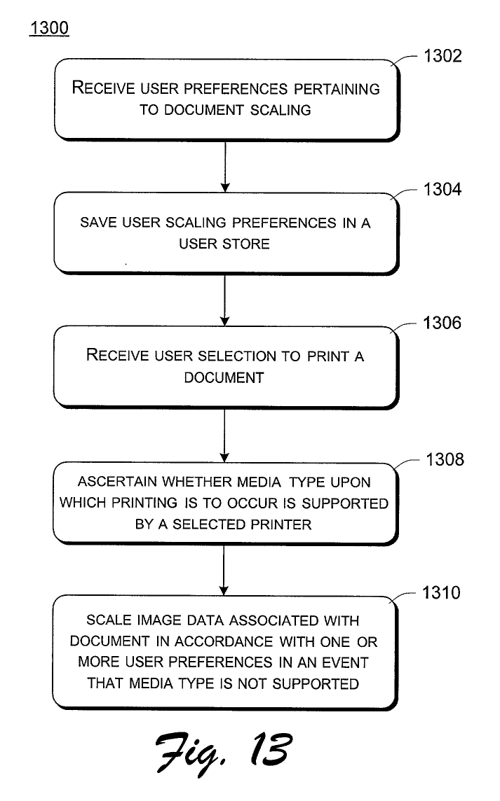

FIG. 12 is another flowchart illustrating an exemplary scaling process 1200 in accordance with one embodiment. The process of FIG. 12 is desirably performed by the above-described network-based or Web-based service which, as described, can be embodied in content 208, content 228, content 232, content 212, device content 236 or device content 238. In a preferred embodiment, the process is implemented, at least in part, in connection with a service associated with a printer.

Step 1202 receives a user selection to print a document. This step is implemented by causing a user interface to be displayed via which the user can select a document for printing. Step 1204 ascertains whether the media type upon which printing is to occur is supported by a selected printer. The step can be implemented in any suitable way, examples of which are given above. Step 1206 automatically scales image data associated with the document to a media type that is supported by the printer, in an event that the media type upon which printing is to occur is not supported by the selected printer. Scaling can be performed using any suitable scaling techniques. Step 1208 prints the document and notifies the user that scaling has occurred.

FIG. 13 is another flowchart illustrating an exemplary process 1300 in accordance with one embodiment. The process of FIG. 13 is desirably performed by the above-described network-based or Web-based service which, as described, can be embodied in content 208, content 228, content 232, content 212, device content 236 or device content 238. In a preferred embodiment, the process is implemented, at least in part, in connection with a service associated with a printer.

Step 1302 receives user preferences that pertain to document scaling. This step is implemented by causing a user interface to be presented to a user so that they can define their preferences with respect to document scaling. Exemplary user preferences are shown and described in connection with FIG. 6. Step 1304 saves the user scaling preferences in a user store such as user profile store 234 (FIG. 3). Step 1306 receives a user selection to print a document and step 1308 ascertains whether the media type upon which printing is to occur is supported by a selected printer. In an event that a particular desired media type is not supported by a selected printer, step 1310 scales image data associated with the document in accordance with one or more user preferences. For example, a user might indicate that their preference is to have their document printed on a media type that is closest in size with a user-selected media type, in the event that the user-selected media type is not supported by the printer. In this case, the scaling operation would take place automatically. Alternately, the user might have multiple preferences and would like to be given an opportunity to select from among their different preference is such an opportunity arises. An example of this was described above.

Some Server Side Issues

Although the inventive embodiments have been described largely in the context of the client side environment, it is to be appreciated and understood that various aspects of the described embodiments can be implemented on the server side. As an example, consider the following. The above-described imaging extension is used to make user information available to content downloaded into the user's browser. In other words, the imaging extension makes information associated with the user's identity available. Thus, one purpose of the imaging extension is to provide access to the user's personal imaging repository.

As was mentioned, this can be accomplished through the imaging extension which extends the behavior of the browser. Although there are advantages to this approach, there are also disadvantages—namely, the browser must somehow be extended. Although it is possible to extend browsers on Windows operating systems, it becomes harder to do this for newer devices like PDAs. Consequently, it is desirable to support the notion of identity without requiring the browser to be extended.

Supporting identity without requiring the browser to be extended can be accomplished by moving the logic normally present in the web content running within the browser into the web server. That is, rather than the web content accessing the user's personal imaging repository, the web server accesses the user's personal imaging repository. In other words, the identity technology is on the server side instead of client side.

One of the problems that arises in this context pertains to the server being able to determine the location of the user's personal imaging repository (more specifically, the user profile which can act as the root of the personal imaging repository). In the client side identity approach, the imaging extension running within the browser implicitly addressed this issue. The content, by virtue of the fact that it is running within the user's browser and accessing the imaging extension, “knows” the identity of the user. For the server, a different approach can be employed since the browser no longer typically provides any sort of hint regarding the user's identity. One approach to solving this problem is to use an authentication website. The website in question can redirect to the authentication website which then determines the identity of the user, and then redirects back to the user with the user identity, including the location of the user's profile. In this scheme, it is assumed that all websites “know” about the authentication server.

Once the user's identity is determined (i.e. the location of the user's profile is know) the website can directly interact with services in the user's personal imaging repository without the aid of the imaging extension. It is also possible to add security to this model. Such could be done using known techniques.

Exemplary Computer System

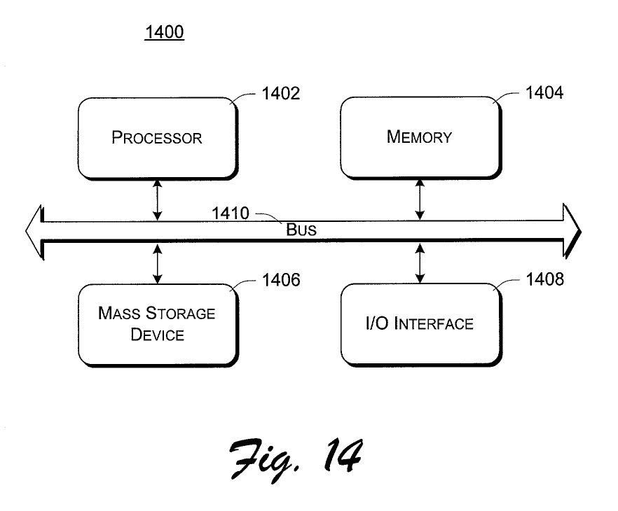

FIG. 14 illustrates an exemplary computer system 1400 in additional detail. Computer system 1400 can be, for example, a network client 102 of FIG. 1, an imaging client 152 or server 154 or 156 of FIG. 2, an imaging client 202, server 210 or 222 of FIG. 3, etc. Computer system 1400 represents a wide variety of computing devices, such as desktop computers, portable computers, dedicated server computers, multi-processor computing devices, cellular telephones, personal digital assistants (PDAs), handheld or pen-based computers, microcontroller-based electronic devices, gaming consoles, and so forth.

Computer system 1400 includes one or more processors 1402, memory 1404, a mass storage device 1406, and an input/output (I/O) interface 1408, all coupled to a bus 1410. Bus 1410 represents one or more buses in computer system 1400, such as a system bus, processor bus, accelerated graphics port (AGP), peripheral component interconnect (PCI), and so forth. The bus architecture can vary by computing device as well as by manufacturer. I/O interface 1408 is a conventional interface allowing components of system 1400 (e.g., processor(s) 1402) to communicate with other computing devices via a network, such as network 158 of FIG. 2. I/O interface 1408 may be, for example, a modem, a network interface card (NIC), and so forth.

Memory 1404 represents volatile and/or nonvolatile memory used to store instructions and data for use by processor 1402. Typically, instructions are stored on a mass storage device 1406 (or nonvolatile memory) and loaded into a volatile memory 1404 for execution by processor(s) 1402. Additional memory components may also be involved, such as cache memories internal or external to processor 1402. Various embodiments can be implemented, at different times, in any of a variety of computer readable media that is part of, or readable by, system 1400. For example, such computer readable media may be mass storage device 1406, memory 1404 or a cache memory, a removable disk (not shown) that is accessible by processor 1402 or another controller of system 1400 (such as a magnet disk or optical disk), and so forth.

Computer system 1400 is exemplary only. It is to be appreciated that additional components (not shown) can be included in system 1400 and some components illustrated in system 1400 need not be included. For example, a display adapter, additional processors or storage devices, additional I/O interfaces, and so forth may be included in system 1400, or mass storage device 1406 may not be included.

I/O interface 1408 is a conventional interface allowing components of system 1400 (e.g., processor 1402) to communicate with other computing devices via a network, such as network 158 of FIG. 2.

The discussions herein refer primarily to software components and modules that can be executed by a computing device. It is to be appreciated, however, that the components and processes described herein can be implemented in software, firmware, hardware, or a combination thereof. By way of example, a programmable logic device (PLD) or application specific integrated circuit (ASIC) could be configured or designed to implement various components and/or processes discussed herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
causing, via at least one network service, a user interface to be presented on a client device, the user interface being configured to notify a user that a printer selected by the user for printing a print job does not support a media type upon which printing is intended; and
performing a scaling operation, via at least one network service, so that the user's print job is printed on at least one different media type.

2. The method of claim 1, wherein said performing is performed automatically, and further comprising notifying the user, via at least one network service, to inform the user that a scaling operation has been performed and that their print job has been printed on a different media type.

3. The method of claim 1 further comprising prior to said performing, causing via at least one network service, a user interface to be presented on the client device that presents a user with one or more user-selectable options for performing a scaling operation so that the user's print job can be printed on a different media type.

4. The method of claim 3, wherein the user interface that is presented on the client device that presents the user with one or more user-selectable options, presents a user with an option to perform a scaling operation using one or more previously-provided user preferences.

5. The method of claim 1, wherein said media types comprise media sizes.

6. The method of claim 1, wherein said acts of causing and performing are implemented, at least in part, by at least one printer.

7. The method of claim 1, wherein said acts of causing and performing are implemented, at least in part, by at least one proxy server that serves as a proxy for at least one printer.

8. One or more computer-readable media having stored thereon computer-readable instructions which, when executed by one or more processors, cause the processors to:
send content to a client device, said content enabling the client device to:
display a user interface on the client device, the user interface being configured to notify a user that a printer selected by the user for printing a print job does not support a media type upon which printing is intended; and
display a selection of user-selectable scaling options that can be utilized so that the user's print job is printed on at least one different media type.

9. One or more computer-readable media as recited in claim 8, wherein the instructions further cause the one or more processors to provide one or more user-selected scaling options to a printer via a network comprising the Internet.

10. A method comprising:
causing, via at least one web service, a user interface to be presented on a client device, the user interface being configured to notify a user that a printer selected by the user for printing a print job does not support a media size upon which printing is intended; and
performing a scaling operation, via at least one web service, so that the user's print job is printed on at least one different media size.

11. The method of claim 10, wherein said performing is performed automatically, and further comprising notifying the user, via at least one web service, to inform the user that a scaling operation has been performed and that their print job has been printed on a different media size.

12. The method of claim 10 further comprising prior to said performing, causing via at least one web service, a user interface to be presented on the client device that presents a user with one or more user-selectable options for performing a scaling operation so that the user's print job can be printed on a different media size.

13. The method of claim 10, wherein said acts of causing and performing are implemented, at least in part, by at least one printer.

14. The method of claim 10, wherein said acts of causing and performing are implemented, at least in part, by at least one proxy server that serves as a proxy for at least one printer.

15. A network service comprising:
a print job scaling module configured to:
notify a user that a print job intended to be printed on a user-selected printer requires a paper size that is not supported by the printer,
the print job scaling module being further configured to receive, as input:
(1) print job image data comprising a user's print job, and
(2) one or more scaling parameters that are associated with the print job and provided by the user on account of being notified that the print job requires a paper size that is not supported by the printer,
the print job scaling module being further configured to process the print job image data using the one or more scaling parameters to provide scaled print job image data.

16. The network service of claim 15, implemented as a web service.

17. A printer embodying the network service of claim 15.

18. A method comprising:
receiving, via a web service, a user selection indicating a document that is to be printed on at least one media type;
retrieving, via a web service, the user-selected document from a web-accessible repository;
receiving, via a web service, a user selection of a printer upon which printing is to take place;
ascertaining, via a web service, whether said at least one media type is supported by the user-selected printer; and
if said at least one media type is not supported by the user-selected printer, performing a scaling operation on data comprising the document and printing the document on the user-selected printer.

19. The method of claim 18 further comprising, prior to said performing, presenting, via a web service, one or more scaling options for user selection.

20. The method of claim 19 further comprising after said presenting, receiving, via a web service, a user selection of a scaling option, said performing of the scaling operation taking place responsive to receiving said user selection.

21. A method comprising:
receiving, with a printer via a web service, a user selection to print a document on a media type;
ascertaining whether the printer supports the media type;
in an event that the printer does not support the media type, automatically scaling image data associated with the document so that the document can be printed on a media type supported by the printer;
printing the document on the printer on the media type supported by the printer; and
notifying the user that the document has been printed on the media type supported by the printer.

22. The method of claim 21, wherein said acts of ascertaining and scaling are performed by a web service executing on the printer.

23. A method comprising:
receiving, via a web service, one or more user preferences that pertain to document scaling;
saving, via a web service, the one or more preferences in a web-accessible user store;
receiving, via a web service, a user selection to print a document;
ascertaining, via a web service, whether a media type upon which the document is intended to be printed is supported by a printer upon which printing is intended;
in an event that an intended media type is not supported by the printer upon which printing is intended, scaling, via a web service, image data associated with the document using one or more user preferences so that the associated document can be printed on the intended printer.

24. The method of claim 23, wherein said acts of receiving one or more user preferences, saving the one or more user preferences, receiving the user selection, ascertaining and scaling are performed by a common web service.

25. The method of claim 23, wherein said acts of receiving one or more user preferences, saving the one or more user preferences, receiving the user selection, ascertaining and scaling are performed by a common web service executing on the printer upon which printing is intended.
